(19) United States
(12) Patent Application Publication
(10) Pub. No.: US 2024/0109550 A1
(43) Pub. Date: Apr. 4, 2024

(54) CONTROL DEVICE, CONTROL METHOD, AND STORAGE MEDIUM

(71) Applicant: HONDA MOTOR CO., LTD., Tokyo (JP)

(72) Inventors: Gakuyo Fujimoto, Wako-shi (JP); Atsushi Kato, Wako-shi (JP); Shigenobu Saigusa, Wako-shi (JP); Kotaro Fujimura, Wako-shi (JP); Misako Yoshimura, Wako-shi (JP); Masamitsu Tsuchiya, Wako-shi (JP)

(21) Appl. No.: 18/372,180

(22) Filed: Sep. 25, 2023

(30) Foreign Application Priority Data
Sep. 29, 2022 (JP) 2022-157037

(51) Int. Cl. B60W 50/14; B60W 30/095

(52) U.S. Cl. CPC B60W 50/14; B60W 30/0956; B60W 2552/53; B60W 2554/4041; B60W 2554/80

(57) ABSTRACT

A control device of an embodiment is a control device that makes a proposal for steering to avoid a risk object present on a traveling direction side of a mobile object to a driver of the mobile object and includes a determiner configured to determine, when it is assumed that the mobile object is caused to travel straight from a current position of the mobile object in a current traveling direction for a predetermined time, whether an assumed reference position of the mobile object intersects a traveling road boundary, and a proposer configured to suppress the proposal when it is determined that the reference position intersects the traveling road boundary, and makes the proposal when it is determined that the reference position does not intersect the traveling road boundary.

### CROSS-REFERENCE TO RELATED APPLICATION

Priority is claimed on Japanese Patent Application No. 2022-157037, filed Sep. 29, 2022, the content of which is incorporated herein by reference.

### BACKGROUND

### Field of the Invention

The present invention relates to a control device, a control method, and a storage medium.

### Description of Related Art

Conventionally, in a vehicle control device that performs steering control when a vehicle passes an obstacle that has a risk of colliding with the vehicle, there has been disclosed a vehicle control device that suppresses deviation of the vehicle from the current traveling lane when steering control ends after the pass (for example, Japanese Unexamined Patent Application, First Publication No. 2019-43298). When it is assumed that the steering control will end at a timing when a host vehicle is expected to pass a risk target, and when it is determined that there is a deviation risk from the current traveling lane of the host vehicle due to the end of the steering control, this vehicle control device performs risk reduction processing to reduce the deviation risk.

### SUMMARY

However, in the technology described above, a technology of simply and accurately determining whether it is an appropriate scene to make a proposal for steering to avoid a risk object has not been considered. For this reason, there are cases where an appropriate proposal cannot be made to a user. The present invention has been made in consideration of such circumstances, and one of the objects is to provide a control device, a control method, and a storage medium that can make a proposal for steering more appropriately.

The control device, the control method, and the storage medium according to the present invention have adopted the following configuration.
(1): A control device according to one aspect of the present invention is a control device that makes a proposal for steering to avoid a risk object present on a traveling direction side of the mobile object to a driver of the mobile object, and includes a determiner configured to determine, when it is assumed that the mobile object is caused to travel straight from a current position of the mobile object in a current traveling direction for a predetermined time, whether an assumed reference position of the mobile object intersects a traveling lane boundary, and a proposer configured to suppress the proposal when it is determined that the reference position intersects the traveling lane boundary, and makes the proposal when it is determined that the reference position does not intersect the traveling lane boundary.
(2): In the aspect of (1) described above, the determiner may assume that the mobile object is caused to travel straight from a current position of the mobile object in a current traveling direction for a predetermined time, and determine whether front and rear areas including an assumed reference position of the mobile object after the predetermined time are located at different positions from a traveling lane in which the mobile object is capable of traveling, and the proposer may suppress the proposal when the determiner determines that the areas are located at the different positions.
(3): In the aspect of (1) described above, the determiner may determine whether front and rear areas including a tip of a virtual line when the virtual line is extended straight from the reference position of the mobile object by a predetermined distance in the current traveling direction are located at different positions from the traveling lane in which the mobile object is capable of traveling, and the proposer may suppress the proposal when the determiner determines that the areas are located at the different positions.
(4): In the aspect of (3) described above, the predetermined distance may be a distance traveled when the mobile object travels straight for a set time at a current speed of the mobile object.
(5): In the aspect of (1) described above, the determiner may repeatedly determine whether the reference position of the mobile object intersects the traveling lane boundary at a predetermined cycle, and the proposer may suppress the proposal when a risk object is present on the traveling direction side of the mobile object in a first period during which it is determined that the assumed reference position of the mobile object intersects the traveling lane boundary, and make the proposal when a risk object is present on the traveling direction side of the mobile object in a second period during which it is not determined that the assumed reference position of the mobile object intersects the traveling lane boundary.
(6): In the aspect of (5) described above, the proposer may not make the proposal when a driver of the mobile object perform a behavior to avoid the risk object before the mobile object approaches the risk object by a predetermined degree or more in the second period.
(7): In the aspect of (6) described above, the proposer may notify of the presence of the risk object using an information provision device when the driver does not visually recognize the risk object in the first period.
(8): A control method according to another aspect of the present invention is a control method for making a proposal regarding steering to avoid a risk object present on a traveling direction side of a mobile object, and includes, by a computer, processing of determining, when it is assumed that the mobile object is caused to travel straight from a current position of the mobile object in a current traveling direction for a predetermined time, whether an assumed reference position of the mobile object intersects a traveling lane boundary, and processing of suppressing the proposal when it is determined that the reference position intersects the traveling lane boundary, and making the proposal when it is determined that the reference position does not intersect the traveling lane boundary.
(9): A storage medium according to still another aspect of the present invention is a computer-readable non-transitory storage medium that has stored a program causing a computer to execute processing of making a proposal regarding steering to avoid a risk object present on a traveling direction side of a mobile object, and the program causes the computer to execute processing of determining, when it is assumed that the mobile object is caused to travel straight from a current position of the mobile object in a current traveling direction for a predetermined time, whether an assumed reference position of the mobile object intersects a traveling lane boundary, and processing of suppressing the proposal when it is determined that the reference position intersects the traveling lane boundary, and making the proposal when it is determined that the reference position does not intersect the traveling lane boundary.

According to the aspects (1) to (9), when it is assumed that a mobile object is caused to travel straight from a current position of the mobile object in a current traveling direction for a predetermined time, the control device can make a proposal for steering more appropriately by suppressing the proposal described above on the basis of an assumed reference position of the mobile object.

### BRIEF DESCRIPTION OF THE DRAWINGS

FIG. 1 is a configuration diagram of a vehicle M in which a driving support device of an embodiment is mounted.

FIG. 2 is a diagram for describing a timing of a notification when there is a risk object.

FIG. 3 is a diagram which shows an example of a risk display.

FIG. 4 is a diagram which shows an example of an oversight notification.

FIG. 5 is a diagram which shows an example of a notification of behavior proposal.

FIG. 6 is a diagram which shows an example of a relationship between an event, a behavior of a driver, and information provided by an HMI.

FIG. 7 is a diagram which shows another example of the relationship between an event, a behavior of a driver, and information provided by an HMI.

FIG. 8 is a flowchart which shows an example of a flow of processing executed by a notification controller.

FIG. 9 is a diagram for describing braking control.

FIG. 10 is a diagram which shows another example of a notification mode.

FIG. 11 is a diagram which shows an example of a functional configuration of a driving support device of a second embodiment.

FIG. 12 is a flowchart which shows an example of a flow of processing executed by a driving support device.

FIG. 13 is a diagram which shows an example of a scene in which an observation point is not included in a specific area.

FIG. 14 is a diagram which shows an example of a scene in which an observation point is included in a specific area.

FIG. 15 is a diagram which shows another example of the scene in which an observation point is included in a specific area.

### DESCRIPTION OF EMBODIMENTS

Hereinafter, embodiments of a control device, a control method, and a storage medium of the present invention will be described with reference to the drawings. In the following description, description is provided on the assumption that a mobile object is a vehicle, but the mobile object may also be an object other than a vehicle.

### First Embodiment

[Overall Configuration]

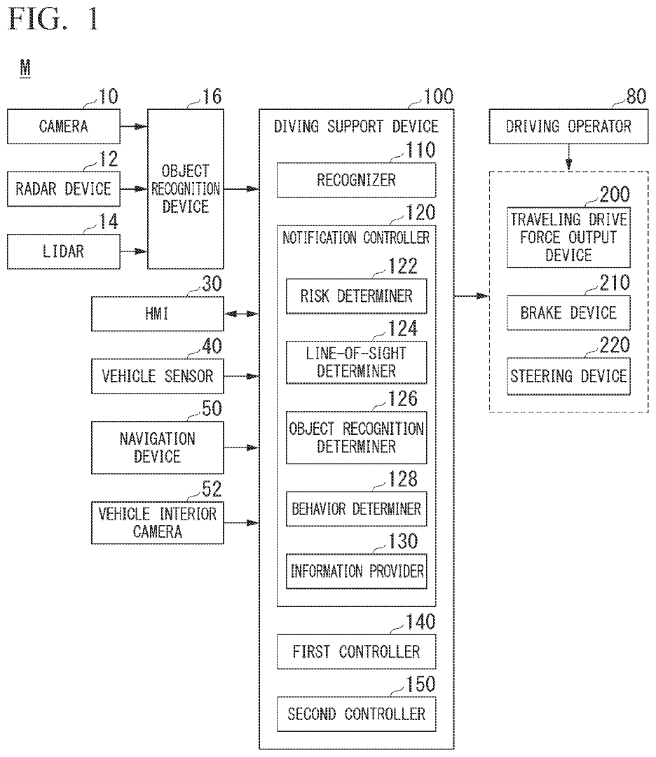

FIG. 1 is a configuration diagram of a vehicle M in which a driving support device 100 of an embodiment is mounted. The vehicle M is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination of these. The electric motor operates by using electric power generated by a generator connected to the internal combustion engine or discharge power of secondary batteries or fuel cells.

The vehicle M is equipped with, for example, a camera 10, a radar device 12, a light detection and ranging (LIDAR) 14, an object recognition device 16, a human machine interface (HMI) 30, and a vehicle sensor 40, a vehicle interior camera 52, a driving operator 80, a driving support device 100, a traveling drive force output device 200, a brake device 210, and a steering device 220. These devices and apparatuses are connected to each other by a multiplex communication line such as a controller area network (CAN) communication line, a serial communication line, a wireless communication network, or the like. The configuration shown in FIG. 1 is merely an example, and a part of the configuration may be omitted or another configuration may be added.

The camera 10 is a digital camera that uses a solid-state imaging sensor such as a charge coupled device (CCD) or a complementary metal oxide semiconductor (CMOS). The camera 10 is attached to an arbitrary place of a vehicle (hereinafter referred to as the vehicle M) in which the vehicle system 1 is mounted. The camera 10 includes, for example, a camera for capturing an image of the front, a camera for capturing an image of the left and front side, a camera for capturing an image of the right and front side, a camera for capturing an image of the left and rear side, and a camera for capturing an image of the right and rear side. For example, the camera 10 that captures an image of the front is attached to a top of the front windshield or a rear surface of the rearview mirror. For example, a camera that captures an image on a left front side is attached to an A pillar on the left side, near the A pillar, near a left side mirror, or the like, a camera that captures an image on a right front side is attached to an A pillar on the right side, near the A pillar, near a right side mirror, or the like, and a camera that captures an image on a left rear side is attached to a C pillar on the left side, near the C pillar, or the like, and a camera that captures an image on a right rear side is attached to a C pillar on the right side, near the C pillar, or the like. These cameras may be installed at any position as long as they can capture an image of a target imaging area. The camera 10 periodically and repeatedly captures, for example, a periphery of the vehicle M. The camera 10 may be a stereo camera.

The radar device 12 radiates radio waves such as millimeter waves to the periphery of the vehicle M, and also detects at least a position (a distance and an orientation) of an object by detecting radio waves (reflected waves) reflected by the object. The radar device 12 is attached to an arbitrary place on the vehicle M. The radar device 12 may detect the position and speed of an object in a frequency modulated continuous wave (FM-CW) method. The radar device 12 may also be attached to, for example, a vicinity of a position where the camera is attached. For example, the camera 10 and the radar device 12 may be attached as a pair.

The LIDAR 14 irradiates the periphery of the vehicle M with light (or electromagnetic waves with wavelengths close to that of light) and measures scattered light. The LIDAR 14 detects a distance to a target based on a time from light emission to light reception. The irradiated light is, for example, a pulsed laser beam. The LIDAR 14 is attached to an arbitrary place on the vehicle M.

The object recognition device 16 performs sensor fusion processing on a result of detection by a part or all of the camera 10, the radar device 12, and the LIDAR 14, and recognizes the position, type, speed, and the like of an object. The object recognition device 16 outputs a result of recognition to the driving support device 100. The object recognition device 16 may output the results of detection by the camera 10, the radar device 12, and the LIDAR 14 to the driving support device 100 as they are. The object recognition device 16 may be omitted from the vehicle system 1. Some or all of the camera 10, the radar device 12, the LIDAR 14, and the object recognition device 16 are examples of a “detection device.”

The HMI 30 presents various types of information to an occupant of the vehicle M and receives an input operation by the occupant. The HMI 30 includes various display devices, speakers, buzzers, vibration generation devices (vibrators), touch panels, switches, keys, and the like. The vibration generation device vibrates, for example, a seat belt of a driver's seat or the steering wheel under control of the driving support device 100. The HMI is an example of an “information provision device.”

The vehicle sensor 40 includes a vehicle speed sensor that detects a speed of the vehicle M, an acceleration sensor that detects acceleration, a yaw rate sensor that detects an angular speed around a vertical axis, an azimuth sensor that detects a direction of the vehicle M, and the like.

The navigation device 50 includes, for example, a global navigation satellite system (GNSS) receiver, a guidance controller, a storage that has stored map information, and the like. The GNSS receiver identifies the position of the vehicle M on the basis of a signal received from a GNSS satellite. The position of the vehicle M may be identified or complemented by an inertial navigation system (INS) using an output of the vehicle sensor 40. The guidance controller determines, for example, a route from the position of the vehicle M (or an arbitrary position to be input) identified by the GNSS receiver to a destination to be input by the occupant with reference to the map information, and outputs guidance information to the HMI 30 such that the vehicle M travels along the route. The map information is, for example, information in which a road shape is expressed by a link indicating a road and nodes connected by a link. The map information may include a road curvature, point of interest (POI) information, and the like. The navigation device 50 may transmit a current position and a destination of the vehicle M to a navigation server via a communication device and acquire a route from the navigation server.

The vehicle interior camera 52 is, for example, a digital camera using a solid-state imaging sensor such as a CCD or CMOS. The vehicle interior camera 52 is attached to a position at which it can capture an image of an occupant of the vehicle M (for example, a driver seated in the driver's seat). The vehicle interior camera 52 captures, for example, an image of an imaging target area at predetermined periodic intervals.

The driving operator 80 includes, for example, an accelerator pedal, a brake pedal, a steering wheel, a shift lever, and other operators. The driving operator 80 has a sensor that detects the amount of operation or a presence or absence of an operation attached thereto, and a result of detection is output to some or all of the traveling drive force output device 200, the brake device 210, and the steering device 220.

The traveling drive force output device 200 outputs a traveling drive force (torque) for traveling of a vehicle to drive wheels. The traveling drive force output device 200 includes, for example, a combination of an internal combustion engine, an electric motor, and a transmission, and an electronic control unit (ECU) that controls these. The ECU controls the configuration described above according to information input from the driving support device 100 or information input from the driving operator 80.

The brake device 210 includes, for example, a brake caliper, a cylinder that transmits hydraulic pressure to the brake caliper, an electric motor that causes the cylinder to generate hydraulic pressure, and an ECU. The ECU controls the electric motor according to the information input from the driving support device 100 or the information input from the driving operator 80 so that brake torque corresponding to a braking operation is output to each wheel. The brake device 210 may have a backup mechanism that transmits the hydraulic pressure generated by operating the brake pedal included in the driving operator 80 to the cylinder via a master cylinder. The brake device 210 is not limited to the configuration described above, and may be an electronically controlled hydraulic brake device that controls an actuator according to the information input from the driving support device 100 and transmits the hydraulic pressure of the master cylinder to the cylinder.

The steering device 220 includes, for example, a steering ECU and an electric motor. The electric motor applies, for example, force to a rack and pinion mechanism to change a direction of a steering wheel. The steering ECU drives the electric motor according to the information input from the driving support device 100 or the information input from the driving operator 80 to change the direction of the steering wheel. For example, the steering device 220 or steering wheel may function as an “information provision device” that informs or notifies the driver of the information. For example, when a proposal is made to the user to avoid a risk object to be described below by rotating the steering wheel or temporarily fixing the steering wheel at a position rotated a predetermined angle, the steering device or steering wheel functions as the “information provision device.”

[Driving Assistance Device]

The driving support device 100 includes, for example, a recognizer 110, a notification controller 120, a first controller 140, and a second controller 150. The notification controller 120 includes, for example, a risk determiner 122, a line-of-sight determiner 124, an object recognition determiner 126, a behavior determiner 128, and an information provider 130. These functional units are realized by a hardware processor such as a central processing unit (CPU) executing a program (software). In addition, some or all of these components may be realized by hardware (a circuit; including circuitry) such as large scale integration (LSI), an application specific integrated circuit (ASIC), a field-programmable gate array (FPGA), or a graphics processing unit (GPU), or may be realized by software and hardware in cooperation. A program may be stored in advance in a storage device (a storage device having a non-transitory storage medium) such as an HDD or flash memory of the driving support device 100, or may be stored in a detachable storage medium such as a DVD or a CD-ROM and installed in the HDD or flash memory of the driving support device 100 by the storage medium (non-transitory storage medium) being attached to a drive device.

Instructions from the driving support device 100 to the traveling drive force output device 200, the brake device 210, and the steering device 220 are set inside the traveling drive force output device 200, the brake device 210, and the steering device 220 so that they are executed with priority over a result of the detection from the driving operator 80. Regarding braking, if a braking force based on an operation amount of the brake pedal is larger than the instructions from the driving support device 100, the latter may be set to be executed with priority. Communication priority in an in-vehicle LAN may be used as a mechanism for executing the instructions from the driving support device 100 with priority.

[Processing when there is Risk Object]

When a risk object is present in front of the vehicle M, the driving support device 100 executes various types of processing on the basis of an index value indicating a degree of proximity of the vehicle M to the risk object and a threshold value.

The “degree of proximity” is represented by various index values that indicate the degree of proximity between objects. For example, the “degree of proximity” is time to collision (TTC), which is an index value obtained by dividing a distance by a relative speed (a direction of approaching each other is set to be positive). If the relative speed is negative (a direction in which they are move away from each other), TTC is provisionally set to infinity. TTC is an index value indicating a higher “degree of proximity” as the value decreases. In this case, satisfying a “first condition” means, for example, that the TTC is less than a first threshold value Th1. The first threshold value Th1 is, for example, a value of about several tenths of a [sec]. Instead of TTC, an index value having similar properties, such as headway time (THW), distance, or another index value, may be used as the “degree of proximity.” A TTC that is adjusted in consideration of acceleration and jerk may be used as the “degree of proximity.” In the following description, description is provided on the assumption that the “degree of proximity” is TTC.

A risk object is, for example, an object that the vehicle M needs to avoid. The risk object is, for example, an object that interferes with movement of the vehicle M in its current state or an object that has a possibility of interfering with it. An object that has the possibility of interfering with it is, for example, an object whose degree of proximity will become equal to or greater than a predetermined degree after a predetermined time when a position, a moving direction, and a moving speed of the object and a position, a moving method, and a moving speed of the vehicle M are considered. The object may be a traffic participant such as a pedestrian, a bicycle, or a vehicle, or may be an object other than a traffic participant such as an object placed on a road or a falling object.

The recognizer 110 recognizes risk objects around the vehicle M on the basis of information input by the object recognition device 16. Recognizing means, for example, recognizing a presence of a risk object classified as described above and a relative position of the risk object with respect to the vehicle M.

The risk determiner 122 determines a direction in which a risk is present on the basis of, for example, a position of the risk object. For example, when the risk object is present in front of the vehicle M, the risk determiner 122 determines that a risk is present in a forward direction.

The line-of-sight determiner 124 analyzes, for example, an image captured by the vehicle interior camera 52 and determines a line-of-sight direction of the driver on the basis of a result of the analysis.

The object recognition determiner 126 determines whether the driver has visually recognized the risk object. For example, information indicating a correlation between the line-of-sight direction of the driver in the image and the position of an object with respect to the vehicle M is stored in advance in a storage device of the driving support device 100. The line-of-sight determiner 124 refers to the information indicating the correlation to determine whether the line-of-sight direction in the specified image matches a position direction of the risk object, and it is determined that the driver visually recognizes the risk object when they match and it is determined that the driver does not visually recognize the risk object when they do not match. Instead of the processing described above, it may be determined whether the driver has visually recognized the risk object using a predetermined algorithm.

The behavior determiner 128 determines a behavior of the driver. A behavior is, for example, a state of an operation of the accelerator pedal, a state of an operation of the steering wheel, a state of an operation of the brake pedal, or the like. The behavior determiner 128 determines the behavior of the driver on the basis of, for example, results of the detections of sensors that detect an operation amount or a presence or absence of an operation of each of the accelerator pedal, the brake pedal, and the steering wheel.

The information provider 130 provides the driver with information according to a result of the determination on the basis of the result of the determination of the object recognition determiner 126 or the behavior determiner 128. Details of this will be described below.

[Notification Timing]

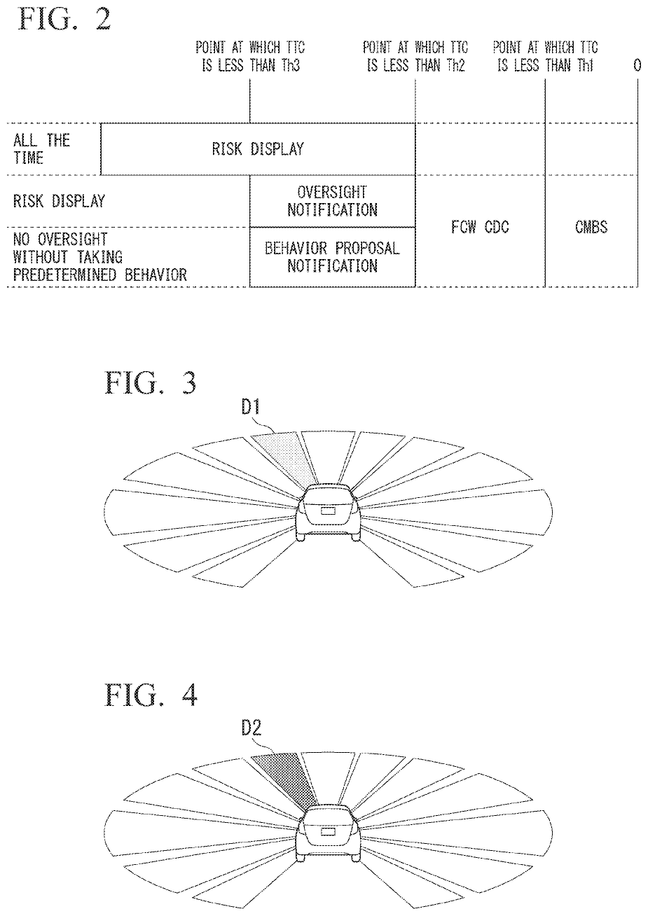

FIG. 2 is a diagram for describing a timing of notification when a risk object is present. When a risk object is present, the information provider 130 causes a display to display a risk display indicating a direction in which the risk object is present. FIG. 3 is a diagram which shows an example of the risk display. For example, as shown in FIG. 3, content is displayed in which the direction (D1 in FIG. 3) in which the risk object is present with respect to the vehicle M can be recognized. The information provider 130 provides, for example, the driver with the risk display until TTC reaches a second threshold value Th2. The second threshold value Th2 is, for example, a value of about 3 [sec] or around 3 [sec]. The risk display, an oversight notification to be described below, and a notification of behavior proposal to be described below are examples of “third processing.”

The information provider 130 performs an oversight notification when the driver does not visually recognize a risk object before the TTC reaches a third threshold value Th3. An oversight notification is a notification that notifies that the driver does not visually recognize a risk object that the driver needs to visually recognize. FIG. 4 is a diagram which shows an example of the oversight notification. For example, as shown in FIG. 4, content is displayed in which the direction (D2 in FIG. 4) in which the risk object is present with respect to the vehicle M can be recognized. For example, the direction in which the risk object is present is notified of in a more emphasized mode than the mode shown in FIG. 3. The emphasized mode may be, for example, a mode in which the driver can more easily visually recognize the direction in which the risk object is present, such as an emphasis by color, an emphasis by blinking or lighting an icon, or the like. The information provider 130 provides, for example, the oversight notification to the driver from when the TTC reaches the third threshold value Th3 to when the TTC reaches the second threshold value Th2. For example, the oversight notification continues even if a risk object is visually recognized when the TTC is between the third threshold value Th3 and the second threshold value Th2. The third threshold value Th3 is, for example, a value of about 4 [sec] or around 4 [sec].

The information provider 130 performs a notification of behavior proposal (fourth processing) when the driver visually recognizes the risk object and the driver does not take a predetermined behavior before the TTC reaches the third threshold value Th3. A notification of behavior proposal is a notification that proposes that the driver perform a behavior to avoid the risk object. The information provider 130 provides, for example, a notification of behavior proposal to the driver from when the TTC reaches the third threshold value Th3 to when the TTC reaches the second threshold value Th2. For example, even if a behavior corresponding to the notification of behavior proposal is performed when the TTC is between the third threshold value Th3 and the second threshold value Th2, the notification of behavior proposal is continued.

A predetermined behavior is, for example, a behavior corresponding to deceleration or a turn. The predetermined behavior is, for example, operating the brake pedal or operating the steering wheel (operator) in a direction in which the risk object is avoided. The predetermined behavior is decreasing an operation amount of the accelerator pedal to an amount smaller than the operation amount thereof a predetermined time ago by a predetermined degree or more, or releasing an operation of the accelerator pedal. Releasing means that the driver stops operating the accelerator pedal and the operation amount becomes zero or nearly zero.

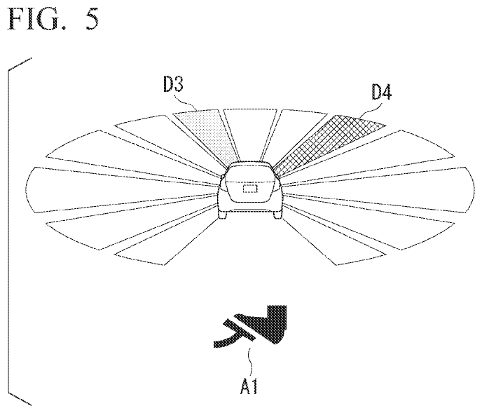

FIG. 5 is a diagram which shows an example of the notification of behavior proposal. For example, as shown in FIG. 5, content is displayed in which the direction (D3 in FIG. 5) in which the risk object is present with respect to the vehicle M can be recognized in the same manner as in FIG. 3 (or FIG. 4). As shown in FIG. 5, the content is displayed so that the driver can recognize a direction (D4 in FIG. 5) in which the vehicle M needs to travel to avoid the risk object. In addition, the content includes information indicating a behavior that the driver needs to perform as the notification of behavior proposal. In FIG. 5, an icon (A1 in FIG. 5) prompting the driver to decelerate by operating the brake pedal is displayed.

The notification of behavior proposal may be a notification by voice instead of a display, a notification by automatically steering the steering wheel in a direction in which the vehicle needs to travel and causing the driver to recognize the traveling direction (a notification by fixing the steering wheel to a position rotated a predetermined angle in a direction corresponding to the traveling direction or a notification by rotating it a predetermined angle and returning it to its original position), a notification by controlling a pretensioner mechanism of the driver's seat belt to strengthen binding force of the seat belt, or a notification by vibrating the seat belt. The information provider 130 provides, for example, the notification of behavior proposal to the driver from when the TTC reaches the third threshold value Th3 to when the TTC reaches the second threshold value Th2.

Here, decreasing the operation amount of the accelerator pedal to an amount smaller than the operation amount thereof a predetermined time ago by a predetermined degree or more or releasing the operation of the accelerator pedal is a predetermined behavior. Although the driver does not perform any behavior to control deceleration or steering, when the driver recognizes a risk object and avoids the risk object, the driver tends to perform an avoidance behavior after reducing the operation amount of the accelerator pedal or stopping an operation of the accelerator pedal. Such a tendency has been found by analyzing results of various experiments and simulations. In this manner, the information provider 130 determines whether to perform the notification of behavior proposal on the basis of whether the predetermined behavior is performed, thereby providing information that reflects an intention of the driver more effectively.

In the example described above, when the driver visually recognizes the risk object while the oversight notification is being performed, the oversight notification may be stopped even before the TTC reaches the second threshold value Th2. In the example described above, when the notification of behavior proposal is performed and the driver performs a behavior corresponding to the proposal or the predetermined behavior, even before the TTC reaches the second threshold value Th2, the notification of behavior proposal may be stopped.

In the example described above, when an event has occurred in which a risk object is present when the TTC is between the third threshold value Th3 and the second threshold value Th2 (for example, when a pedestrian suddenly rushes out), the information provider 130 performs notification together with risk display on the basis of the behavior of the driver at that time. For example, when the driver does not visually recognize the risk object, the information provider 130 performs the oversight notification, and performs the notification of behavior proposal when the driver visually recognizes the risk object and does not perform the predetermined behavior.

### Specific Example 1

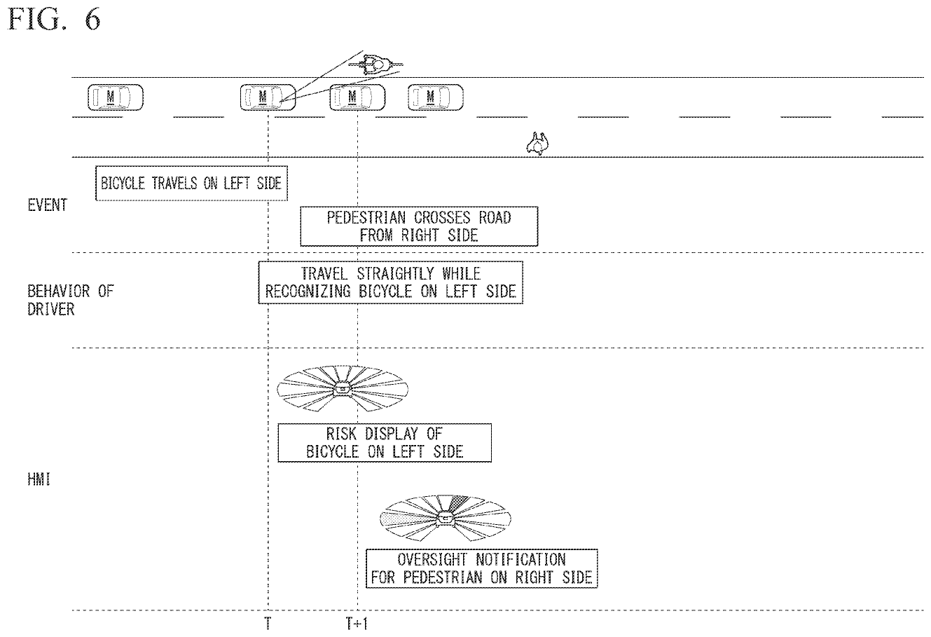

FIG. 6 is a diagram which shows an example of a relationship between an event, the behavior of the driver, and information provided in the HMI. It is assumed that the vehicle M is traveling straight on a road. At this time, a bicycle is traveling on a left side of the vehicle M. At a time T, the driver of the vehicle M visually recognizes the bicycle, and the driver causes the vehicle M to move straight ahead while recognizing the bicycle. In this case, the information provider 130 causes a display to display a risk display indicating a direction of the bicycle with respect to the vehicle M. After that, at a time T+1, it is assumed that a pedestrian who is about to cross the road from a right side of the vehicle M appears. At this time, when the driver does not visually recognize the pedestrian, the information provider 130 causes the display to display an oversight notification of the pedestrian.

As described above, the information provider 130 notifies the driver of appropriate information on the basis of a degree of the driver's awareness of the surroundings. As a result, the driver can control the vehicle M to cause the vehicle M to avoid the risk object with sufficient margin.

### Specific Example 2

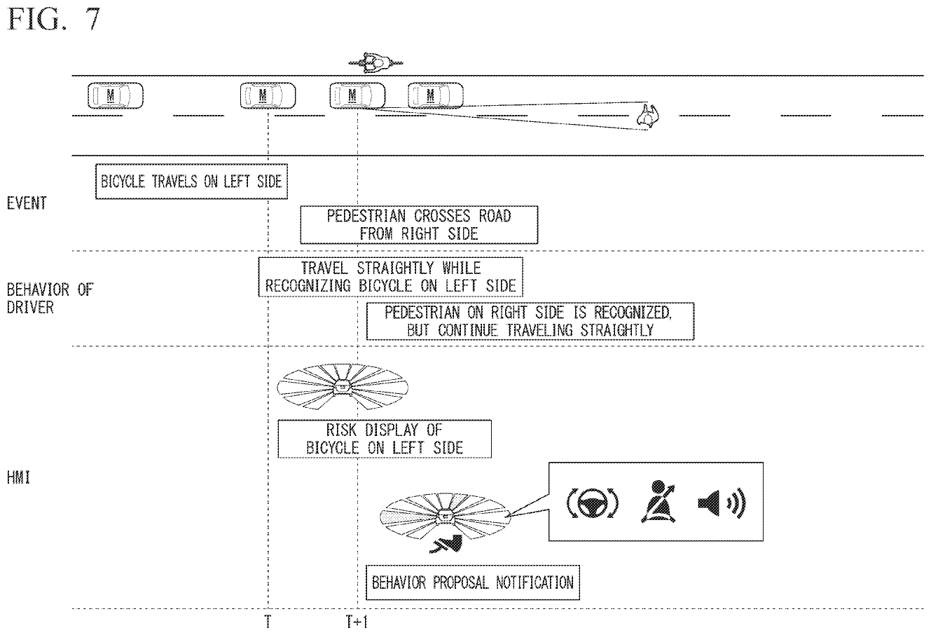

FIG. 7 is a diagram which shows another example of the relationship between an event, the behavior of the driver and the information provided in the HMI. Differences from FIG. 6 will be mainly described. It is assumed that a pedestrian who is about to cross the road appears on the right side of the vehicle M at the time T+1. At this time, when the driver visually recognizes the pedestrian and does not perform the predetermined behavior, the information provider 130 performs the notification of behavior proposal.

As described above, the information provider 130 notifies the driver of appropriate information on the basis of the degree of the driver's awareness of the surroundings and the behavior of the driver. As a result, the driver can control the vehicle M to cause the vehicle M to avoid the risk object with sufficient margin.

[Flowchart]

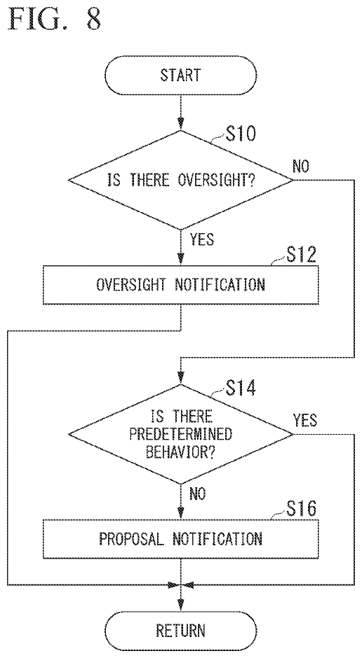

FIG. 8 is a flowchart which shows an example of a flow of processing executed by the notification controller 120. In this processing, it is assumed that a risk object is present at a predetermined distance from the vehicle M. First, the notification controller 120 determines whether the driver is overlooking the risk object (step S10). When the driver is overlooking the risk object (when the driver is not visually recognizing it), the notification controller 120 performs an oversight notification (step S12).

When the driver is not overlooking the risk object (when the driver is visually recognizing it), the notification controller 120 determines whether the driver is performing a predetermined behavior (step S14). When the predetermined behavior is performed, one routine of this processing ends. In this case, for example, a risk display indicating a direction of the position of the risk object with respect to the vehicle M is displayed on the display.

When the predetermined behavior has not been performed, the notification controller 120 performs the notification of behavior proposal (step S16). As a result, one routine of this processing ends.

As described above, the notification controller 120 can notify the driver of appropriate information on the basis of the degree of driver's awareness of the surroundings and the behavior of the driver. For example, the notification controller 120 does not perform the notification of behavior proposal when the driver is performing a predetermined behavior, thus reducing annoyance for the driver. In particular, when the operation amount of the accelerator pedal of the driver decreases or when the driver stops operating the accelerator pedal, since the driver is presumed to be performing a behavior to avoid the risk object, the notification controller 120 suppresses a notification to the driver. As a result, the notification controller 120 can provide information that reflects the intention of the driver.

In the example described above, description is provided on the assumption that an oversight notification or a notification of behavior proposal is displayed, but an oversight notification and a notification of behavior proposal may be displayed at the same time. For example, information indicating that deceleration will be performed may be notified in the oversight notification, or the steering wheel may be automatically rotated or vibrated so that the driver can recognize the avoidance direction of the risk object.

One or both of the oversight notification and the notification of behavior proposal may be omitted. For example, the oversight notification may not be performed when the driver is overlooking the risk object. The notification of behavior proposal may be performed even if the driver is overlooking the risk object.

[Braking Control]

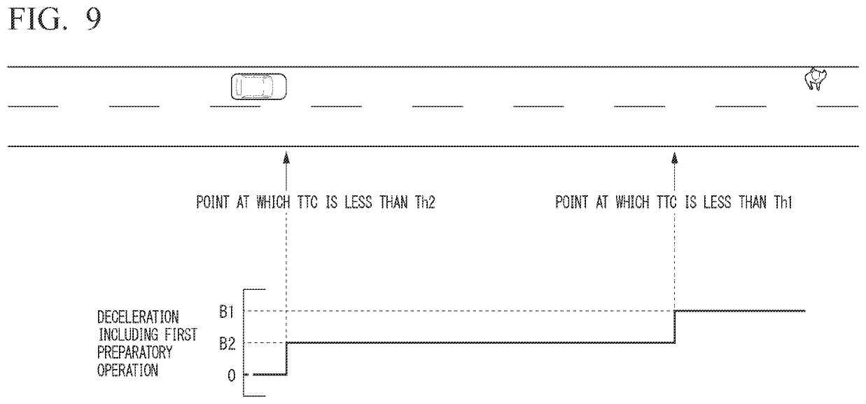

Processing when the TTC is less than the second threshold value Th2 and when the TTC is less than the first threshold value Th1 will be described below with reference to FIG. 9. FIG. 9 is a diagram for describing braking control.

The first controller 140 performs a first operation to notify the driver of the vehicle M of the presence of a risk object when the degree of proximity between the risk object and the vehicle M satisfies a predetermined condition (for example, when the TTC is less than the second threshold value Th2). The first operation is, for example, an operation of instructing the brake device 210 and/or the traveling drive force output device 200 to output a braking force that causes the vehicle M to decelerate to a second deceleration B2 during a period from when the TTC is less than the second threshold value Th2 to when it is less than the first threshold value Th1. The second deceleration B2 is a deceleration that is smaller (closer to zero) than a first deceleration B1. The second threshold value Th2 is a value larger than the first threshold value Th1. The first operation is so-called CDC control. At this time, a warning (FCW) indicating that the risk object ahead is approached may also be output. Deceleration by braking force may be performed after the warning (FCW) is performed for a predetermined time.

The second controller 150 performs a second operation when the TTC is less than the first threshold value Th1. The second operation is an operation for controlling the vehicle M so that the vehicle M does not come into contact with the risk object (rear-end collision reduction brake; CMBS). The second controller 150 instructs, for example, the brake device 210 and/or the traveling drive force output device 200 to output braking force that causes the vehicle M to decelerate to the first deceleration B1. The first deceleration B1 is, for example, a deceleration of about several tenths of a [G] (close to 1). Accordingly, the second controller 150 causes the vehicle M to quickly decelerate and stop to avoid contact with the risk object. The ECU of the brake device 210 or the traveling drive force output device 200 has a function of obtaining a brake output, a regenerative control amount, an engine brake amount, and the like based on the instructed deceleration, and the ECU determines a control amount of each on the basis of the instructed deceleration and a speed of the vehicle M. This is a well-known technology, and detailed description thereof will be omitted.

The second controller 150 may determine, for example, whether an object is present in a side area extending from slightly in front of the risk object to the rear, and cause the vehicle M to avoid the risk object by causing it to travel on a traveling road on a side of the risk object when an object is not present. For example, the second controller 150 may cause the vehicle to travel on the traveling road on a side when it is difficult to avoid the risk object due to the braking force.

In the example described above, description is provided on the assumption that when the TTC is less than the second threshold value Th2 or less than the first threshold value Th1, CDC or CMBS is executed. Alternatively (or in addition), a traffic sign detection function (TSR), a traffic light detection function (TLI), a function to detect or warn vehicles approaching from the left and right sides of the vehicle, an automatic steering avoidance function, an emergency braking system, and the like may be activated to execute various types of control. For example, when the vehicle M passes through an intersection, the traffic sign detection function (TSR), the traffic light detection function (TLI), the function to detect or warn vehicles approaching from the left and right of the vehicle may be activated, or the automatic steering avoidance function may be activated when the vehicle M is approaching a pedestrian.

[Notification According to Road Structure]

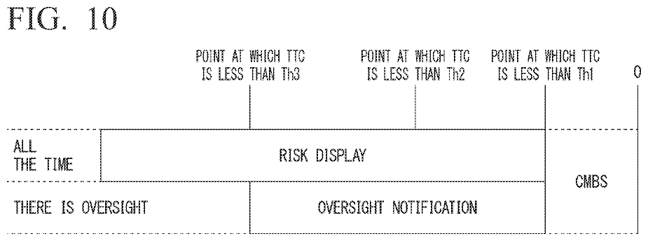

The notification controller 120 may omit that the vehicle M makes a proposal notification depending on a road structure. FIG. 10 is a diagram which shows another example of a notification mode. For example, when the vehicle M enters an intersection and is about to turn right or left, and the risk object is of a particular type, such as a pedestrian, the proposal notification may be omitted. Furthermore, in this case, the warning (FCW) and CDC control may be omitted, and the oversight notification may be performed until the TTC reaches the first threshold value Th1. This is because it is difficult to predict movement of the pedestrian at the intersection, and it is not possible to easily propose a behavior.

As described above, the notification controller 120 can notify the driver of appropriate information on the basis of the degree of the driver's awareness of the surroundings and the behavior of the driver. As a result, the notification controller 120 can provide information that reflects the intention of the driver.

The thresholds Th1 to Th3 described above may be changed according to the speed of the vehicle M and performance and specifications of various devices for recognizing risk objects (the specifications and functions of the camera 10, the radar device 12, the LIDAR 14, the object recognition device 16, and the recognizer 110). For example, it may be set on the basis of a distance at which various devices can recognize an object.

According to the first embodiment described above, the driving support device 100 can perform processing of proposing a driving operation for avoiding the risk object to the driver when the index value is equal to or greater than the second threshold value Th2, and provide information that reflects the intention of the driver by not performing the processing described above when the driver performs a behavior for reducing or releasing an operation of the operator that instructs an acceleration operation to cause the vehicle M to accelerate.

### Second Embodiment

A second embodiment will be described below. In the second embodiment, the driving support device determines whether to perform the notification of behavior proposal on the basis of a result of determining whether a road shape is a shape for which the notification of behavior proposal is performed. For example, the driving support device 100 suppresses the notification of behavior proposal when the road shape is not a shape for which the notification of behavior proposal is performed even when the conditions for performing the notification of behavior proposal are satisfied. For example, when it is assumed that the vehicle M is caused to travel straight from the current position of the vehicle M in the current direction of travel for a predetermined period of time, the driving support device 100 suppresses the notification of behavior proposal when the assumed reference position of the vehicle M (an arbitrary position such as a tip of the vehicle or a center of gravity of the vehicle) intersects the traveling road boundary (or when the reference position is present in a position different from a travelable traveling road of the vehicle M), and performs the notification of behavior proposal when it does not intersect the traveling road boundary (for example, perform the notification of behavior proposal without suppression). A travelable traveling road is a lane or a road on which the vehicle M travels.

Suppression means, for example, not to perform a notification. Suppression may be, for example, weakening a mode of the notification of behavior proposal than the mode of the notification of behavior proposal performed in the case of the road shape for which the notification of behavior proposal is performed. For example, unsuppressed modes of the notification of behavior proposal are modes which are easier for the driver to recognize than the suppressed modes of the notification of behavior proposal.

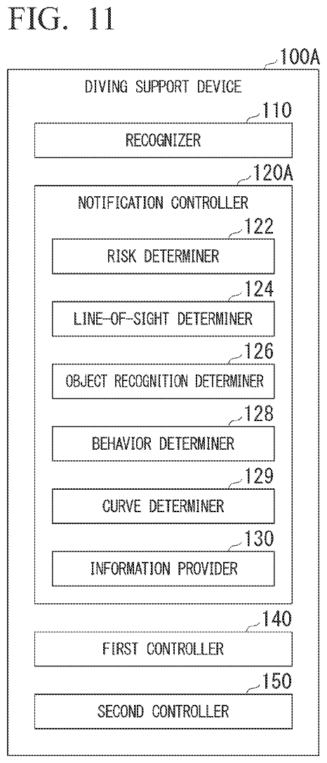

FIG. 11 is a diagram which shows an example of a functional configuration of the driving support device 100A of the second embodiment. Differences from the driving support device 100 will be mainly described. The notification controller 120A of the driving support device 100A further includes, for example, a curve determiner 129 (“determiner”) in addition to functional constituents included in the notification controller 120 of the driving support device 100. The curve determiner 129 is realized by, for example, a hardware processor such as a CPU executing a program (software). The curve determiner 129 may be realized by hardware (a circuit; including circuitry) such as LSI, ASIC, FPGA, GPU, or the like, or may be realized by software and hardware in cooperation. The program may be stored in advance in a storage device (storage device having a non-transitory storage medium) such as the HDD or flash memory of the driving support device 100, or may be stored in a removable storage medium such as a DVD or CD-ROM and may be installed in the HDD or flash memory of the driving support device 100 by the storage medium (the non-transitory storage medium) being attached to a drive device. Details of processing of the curve determiner 129 will be described below.

[Flowchart]

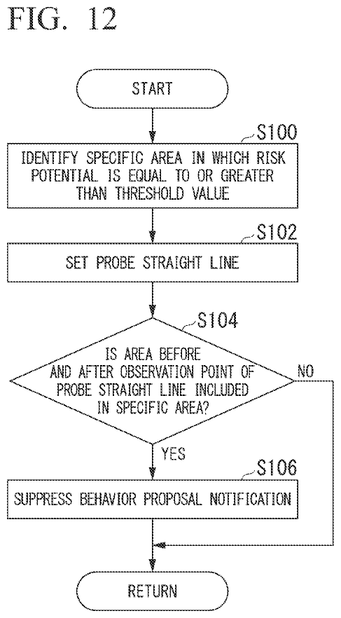

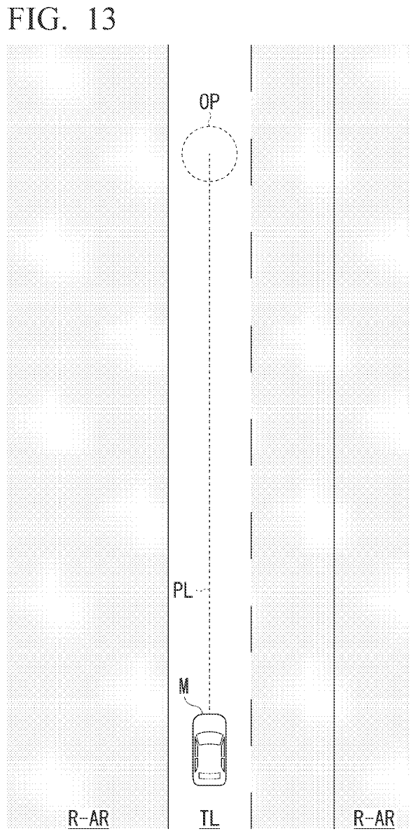

FIG. 12 is a flowchart which shows an example of a flow of processing executed by the driving support device 100A. An order of processing described below is an example, and may be changed as appropriate or other processing may be added thereto.

First, the curve determiner 129 identifies a specific area in which risk potential is equal to or greater than a threshold value (step S100). A specific area whose risk potential is equal to or greater than a threshold value is an area that the vehicle M needs to avoid when traveling. For example, the curve determiner 129 recognizes a lane and a road on which the vehicle M travels on the basis of a result of the recognition of the recognizer 110, and identifies a specific area on the basis of the result of the recognition. For example, the curve determiner 129 identifies an area other than the traveling road on which the vehicle M travels as a specific area. The traveling road is an area within a lane in which the vehicle M travels. As shown in FIG. 13, an area different from a traveling road TL is a specific area R-AR.

Next, the curve determiner 129 sets a probe straight line (step S102). As shown in FIG. 13, a probe straight line PL extending from the reference position of the vehicle M in the traveling direction of the vehicle M is set. A length of the probe straight line is determined according to a moving speed of the vehicle M. The length of the probe straight line is set according to, for example, a timing at which a notification of behavior proposal is performed. For example, when a proposal for an event (for example, a risk object) 4 seconds ahead is made, it is a distance traveled by the vehicle M in 4 seconds or a little longer than 4 seconds. A speed for determining the distance traveled by the vehicle may be determined on the basis of the current speed and acceleration of the vehicle M, a model for determining future changes in speed stored in advance in the storage device of the driving support device 100A, and the like. The length of the probe straight line is calculated on the basis of the set time as described above.

Next, the curve determiner 129 determines whether an area before and after an observation point of the probe straight line is included in the specific area (step S104). An observation point is, for example, a tip (OP) or around the tip of the probe straight line as shown in FIG. 13. When the area before and after the observation point of the probe straight line is not included in the specific area, processing of one routine of this flowchart ends. For example, when the area before and after the observation point OP is not included in the specific area as shown in FIG. 13, the processing of one routine of this flowchart ends.

When the area before and after the observation point of the probe straight line is included in the specific area, the information provider 130 suppresses the notification of behavior proposal on the basis of a result of the determination in step S104 (step S106). For example, the information provider 130 does not perform the notification of behavior proposal even if the conditions for performing the notification of behavior proposal are satisfied (for example, even when a risk object is present and the driver does not perform a predetermined behavior) when the index value reaches the third threshold value Th3 in the processing of the first embodiment. The information provider 130 does not have to perform the notification of behavior proposal for a predetermined period of time after the processing of step S106 is performed, even if the conditions for performing the notification of behavior proposal are satisfied. As a result, processing of one routine in this flowchart ends.

As described above, the driving support device 100A does not perform the notification of behavior proposal when a risk object is present on the traveling direction side of the vehicle M in a first period in which the area before and after the observation point of the probe straight line is included in the specific area, and performs the notification of behavior proposal when a risk object is present on the traveling direction side of the vehicle M in a second period in which the area before and after the observation point of the probe straight line is not included in the specific area, thereby making a proposal for steering depending on a scene in which the vehicle M is placed. Instead of not performing the notification of behavior proposal when a risk object is present on the traveling direction side of the vehicle M in the first period, the notification of behavior proposal may also be suppressed. Suppression means that the notification of behavior proposal is made in a more suppressed manner than the notification of behavior proposal that is made when a risk object is present on the traveling direction side of the vehicle M in the second period. Suppression is, for example, to make a proposal such that the driver performs a behavior while paying attention to the surroundings, or to make a proposal such that the driver performs a behavior by considering that the road is curved.

As described in the first embodiment, since the driving support device 100A does not perform the notification of behavior proposal when the driver of the vehicle M performs a behavior to avoid a risk object before the vehicle M approaches the risk object by a predetermined degree or more (before the third threshold value Th3 is reached) in the second period, it can provide information that reflects the intention of the driver. Furthermore, as described in the first embodiment, the driving support device 100A notifies the driver of the presence of the risk object using the information provision device when the driver does not visually recognize the risk object in the first period, thereby it can cause the driver to recognize the risk object.

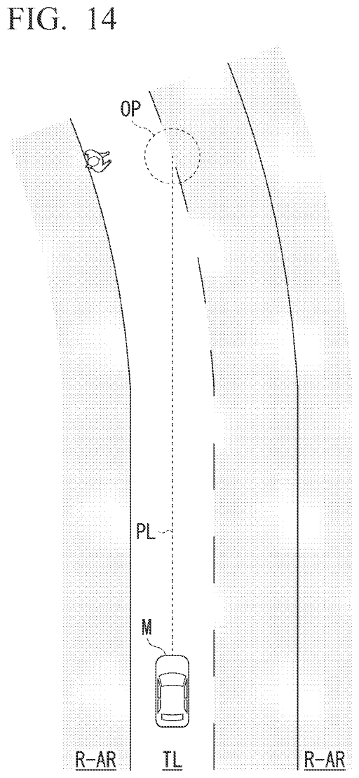

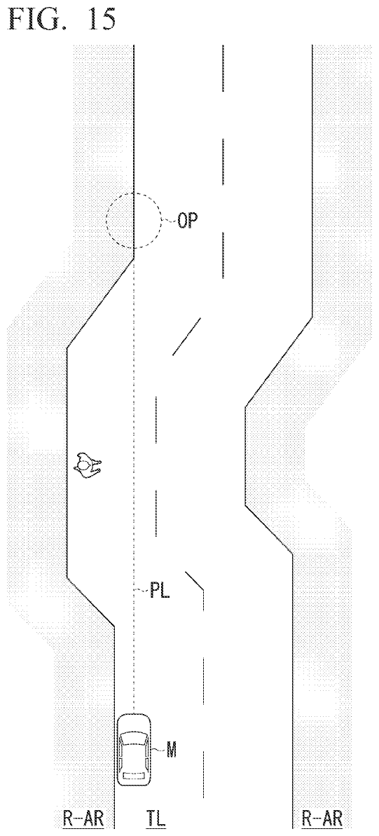

FIG. 14 is a diagram which shows an example of a scene in which an observation point is included in a specific area. For example, as shown in FIG. 14, when the traveling road on which the vehicle M travels is a curved road and the observation point OP is included in the specific area R-AR, the information provider 130 does not perform the notification of behavior proposal even when the conditions for performing the notification of behavior proposal are satisfied.

FIG. 15 is a diagram showing another example of a scene in which an observation point is included in a specific area. For example, as shown in FIG. 15, when a part of the track on which the vehicle M travels has a curved shape (shape like a trapezoidal wave) and the vehicle M is traveling on the left side of the track, the observation point OP may be included in the specific area R-AR. In this case, the information provider 130 does not perform the notification of behavior proposal even if the conditions for performing the notification of behavior proposal are satisfied.

In each of the examples described above, it is determined whether the observation point OP is included in the specific area, but instead of (or in addition to) this, it is determined whether a part of the probe straight line is included in the specific area R-AR, and when it is included, the notification of behavior proposal may be suppressed.

When the probe straight line intersects an edge of the lane in which the vehicle M travels (for example, a road division line) or an edge of the road on which the vehicle M travels (for example, a curb, a guardrail, or the like), the notification of behavior proposal may be suppressed.

Here, while the driver of the vehicle M is driving, when there is a risk object such as a traffic participant or an obstacle in front of the vehicle M and the driver does not perform a behavior to avoid the risk object, it is desirable that a notification, automatic control of the vehicle M, a guidance for taking avoidance behavior, and the like be performed as a driving support for avoiding the risk object. When this driving support is performed, it is preferable to determine operating conditions and to operate the driving support in scenes where it is appropriate to provide the driving support. For example, it is preferable to suppress proposals on a road of a predetermined shape such as a curved road. Especially when an avoidance direction and a risk direction are intuitively guided through visual, tactile, and auditory senses, driving support in a straight line is mainly used. For example, when the guidance described above is performed on a curved road, the driver may be confused between avoidance to one side in a lane of the road and avoidance to the absolute traveling direction of the vehicle M (for example, whether the guidance is for traveling along the curved road or for avoiding the risk object). For this reason, on a road of a predetermined shape such as a curved road, it is preferable to perform control different from that for a straight road, or to suppress a proposal for steering.

For example, when a lane edge and a road edge are recognized and the shape of a road is identified based on a radius of curvature of the recognized edge, it is easy to identify the shape of a road for roads with simple curvature, but it is difficult to determine the shape or a large amount of calculation is required for roads with complex shapes (for example, a trapezoidal wave and the like).

Therefore, when it is assumed that the vehicle M is caused to travel straight for the predetermined time as described above, the driving support device 100A of the present embodiment determines whether to make a proposal for steering using the assumed reference position of the vehicle M. In this manner, the driving support device 100 can determine whether the vehicle M is traveling in a scene for which a proposal needs to be made with a very small amount of calculation.

According to the second embodiment described above, the driving support device 100A can make a proposal for steering to avoid a risk object present on the traveling direction side of the vehicle M to the driver of the vehicle M, and make, when it is assumed that the vehicle M is caused to travel straight from a current position of the vehicle M in a current traveling direction for a predetermined time, a more appropriate proposal for steering by making the proposal on the basis of the assumed reference position of the vehicle M.

The embodiment described above can be expressed as follows.

A control device includes a storage medium that stores computer-readable instructions and a processor connected to the storage medium, in which the processor executes the computer-readable instructions to perform first processing when an index value indicating a degree of proximity of a mobile object to a risk object present in front is less than a first threshold value, and perform second processing different from the first processing when the index value is equal to or greater than the first threshold value and less than a second threshold value larger than the first threshold value, there are one or more control devices that perform third processing different from the first processing and the second processing when the index value is equal to or greater than the second threshold, the third processing includes fourth processing of proposing to a driver a driving operation to avoid the risk object, and the fourth processing is not performed when the driver performs a behavior for reducing or releasing an operation of an operator instructing an acceleration operation for causing the mobile object to accelerate.

The embodiment described above can be expressed as follows.

A control device includes a storage medium that stores computer-readable instructions and a processor connected to the storage medium, in which the processor executes the computer-readable instructions to make a proposal for steering to avoid a risk object present on a traveling direction side of a mobile object to a driver of the mobile object, determine, when it is assumed that the mobile object is caused to travel straight from a current position of the mobile object in a current traveling direction for a predetermined time, whether an assumed reference position of the mobile object intersects a traveling road boundary, and suppress the proposal when it is determined that the reference position intersects the traveling road boundary, and makes the proposal when it is determined that the reference position does not intersect the traveling road boundary.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A control device that makes a proposal for steering to avoid a risk object present on a traveling direction side of a mobile object to a driver of the mobile object, comprising:
a determiner configured to determine, when it is assumed that the mobile object is caused to travel straight from a current position of the mobile object in a current traveling direction for a predetermined time, whether an assumed reference position of the mobile object intersects a traveling road boundary; and
a proposer configured to suppress the proposal when it is determined that the reference position intersects the traveling road boundary, and makes the proposal when it is determined that the reference position does not intersect the traveling road boundary.

2. The control device according to claim 1,
wherein the determiner assumes that the mobile object is caused to travel straight from a current position of the mobile object in a current traveling direction for a predetermined time, and determines whether front and rear areas including an assumed reference position of the mobile object after the predetermined time are located at different positions from a travelable traveling road of the mobile object, and
the proposer suppresses the proposal when the determiner determines that the areas are located at the different positions.

3. The control device according to claim 1,
wherein the determiner determines whether front and rear areas including a tip of a virtual line when the virtual line is extended straight from the reference position of the mobile object by a predetermined distance in the current traveling direction are located at different positions from the travelable traveling road of the mobile object, and
the proposer suppresses the proposal when the determiner determines that the areas are located at the different positions.

4. The control device according to claim 3,
wherein the predetermined distance is a distance traveled when the mobile object travels straight for a set time at a current speed of the mobile object.

5. The control device according to claim 1,
wherein the determiner repeatedly determines whether the reference position of the mobile object intersects the traveling road boundary at a predetermined cycle, and
the proposer suppresses the proposal when a risk object is present on the traveling direction side of the mobile object in a first period during which it is determined that the assumed reference position of the mobile object intersects the traveling road boundary, and makes the proposal when a risk object is present on the traveling direction side of the mobile object in a second period during which it is not determined that the assumed reference position of the mobile object intersects the traveling road boundary.

6. The control device according to claim 5,
wherein the proposer does not make the proposal when a driver of the mobile object perform a behavior to avoid the risk object before the mobile object approaches the risk object by a predetermined degree or more in the second period.

7. The control device according to claim 6,
wherein the proposer notifies of the presence of the risk object using an information provision device when the driver does not visually recognize the risk object in the first period.

8. A control method for making a proposal for steering to avoid a risk object present on a traveling direction side of a mobile object, comprising:
by a computer,
processing of determining, when it is assumed that the mobile object is caused to travel straight from a current position of the mobile object in a current traveling direction for a predetermined time, whether an assumed reference position of the mobile object intersects a traveling road boundary; and
processing of suppressing the proposal when it is determined that the reference position intersects the traveling road boundary, and making the proposal when it is determined that the reference position does not intersect the traveling lane boundary.

9. A computer-readable non-transitory storage medium that has stored a program causing a computer to execute processing of making a proposal for steering to avoid a risk object present on a traveling direction side of a mobile object, the program causing the computer to execute:
processing of determining, when it is assumed that the mobile object is caused to travel straight from a current position of the mobile object in a current traveling direction for a predetermined time, whether an assumed reference position of the mobile object intersects a traveling road boundary, and
processing of suppressing the proposal when it is determined that the reference position intersects the traveling road boundary, and making the proposal when it is determined that the reference position does not intersect the traveling lane boundary.
